(19) United States
(12) Patent Application Publication
(10) Pub. No.: US 2006/0032239 A1
(43) Pub. Date: Feb. 16, 2006

(54) Boil-off gas removal system

(75) Inventors: Jack W. Sudduth, Huntley, IL (US); Warren A. Carpenter, Carol Stream, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: CHICAGO BRIDGE & IRON COMPANY

(21) Appl. No.: 10/916,704

(22) Filed: Aug. 12, 2004

(51) Int. Cl. F17C 3/10; F25J 3/00

(52) U.S. Cl. 62/48.2

(57) ABSTRACT

In a new boil-off gas removal system for a liquid storage tank, boil-off vapor from the storage tank is first pressurized in the low-stage compressor. The pressurized vapor may be cooled to near cryogenic temperature in a cooler that can include a preliminary cooler and/or a high-pressure gas exchanger in which the pressurized vapor is cooled against boil-off vapor. The pressurized vapor may also be cooled by the addition of cryogenic liquid through a branch on the liquid supply line running from the low-stage pump in the storage tank. The cooled, pressurized vapor is directed to a heat exchanger where the cool, pressurized vapor travels in a path in which it is condensed against cryogenic liquid that travels in another, separate path.

### BACKGROUND OF THE INVENTION

This invention relates generally to storage and distribution systems for liquified natural gas. More specifically, it relates to a boil-off gas removal system for condensing boil-off vapor from a refrigerated liquid storage tank and routing the condensed liquid into a distribution system.

Liquified natural gas is stored at many locations throughout the world. It is typically stored in storage tanks at import terminals, where it is kept in liquid form at low pressure and temperature. Heat input to storage tanks often generates boil-off vapor. Additional vapor may be produced during filling of the storage tank.

For distribution, liquified natural gas is commonly pumped to a relatively high pressure. The high pressure liquid is then vaporized and sent to the distribution pipeline. The pumping operation typically involves a low pressure pump within the storage tank and a remote high pressure pump.

In one known arrangement, boil-off vapor is cooled in a desuperheater that uses cold liquid from the storage tank to cool the vapor to near saturation temperature. The cooled vapor is then compressed in cryogenic reciprocating compressors, which can raise the temperature of the gas to near ambient temperature. The compressed vapor may be up to almost 400 degrees F. warmer than the stored liquid, and thus is cooled against cold liquid in a shell-and-tube heat exchanger. One drawback of this arrangement is that shell-and-tube heat exchangers are expensive. Unfortunately, less expensive platefin heat exchangers are very sensitive to high temperature differences (which result in high stresses in the unit and can lead to premature failure), and thus cannot be used in this arrangement.

### SUMMARY OF THE INVENTION

The invention comprises a new boil-off gas removal system for a liquid storage tank that permits the use of platefin heat exchangers. The system includes what is believed to be a novel arrangement of a low-stage compressor and a heat exchanger. Before entering the heat exchanger, pressurized vapor from the compressor is cooled through either a cooler or the addition of cryogenic liquid.

Boil-off vapor from the storage tank is first pressurized in the low-stage compressor. Preferably, the low-stage compressor is capable of pressurizing boil-off vapor from a liquid natural gas terminal, and preferably can pressurize it to at least 100 psi.

The pressurized vapor may be cooled to near cryogenic temperature in a cooler. The cooler may include, for example, a preliminary cooler and/or a high-pressure gas exchanger in which the pressurized vapor is cooled against boil-off vapor.

The pressurized vapor may also be cooled by the addition of cryogenic liquid. For example, cryogenic liquid may be introduced through a branch on the liquid supply line that leads from the low-stage pump in the storage tank to the heat exchanger. Preferably, the branch enables the desuperheating of pressurized vapor in the pressurized vapor line, or its cooling to within about 5 degrees F. of the temperature of liquid in the storage tank. An optional separator may be provided on the pressurized vapor line.

The pressurized vapor is directed to the heat exchanger after it has been cooled. The heat exchanger is preferably a platefin heat exchanger or a plate frame heat exchanger, and the cool, pressurized vapor travels in one path in which it is condensed against cryogenic liquid that travels in another, separate path. Optionally, a valve may be provided to control the amount of cryogenic liquid entering the heat exchanger.

A receiver vessel may also be provided, in which condensate from the heat exchanger is mixed with cryogenic liquid.

### BRIEF DESCRIPTION OF THE DRAWINGS

One embodiment of the invention may be seen in the accompanying drawing, in which:

FIG. 1 is a schematic of a boil-off gas removal system in accordance with the present invention.

### DETAILED DESCRIPTION OF THE DRAWINGS

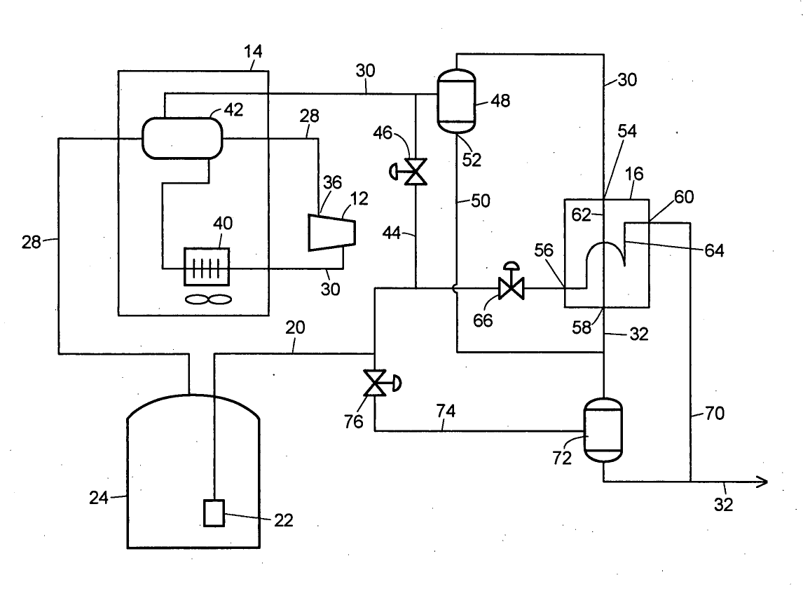

The boil-off gas removal system that is seen in FIG. 1 includes a low-stage compressor 12, a cooler 14, and a heat exchanger 16. A liquid supply line 20 leads from a low-stage pump 22 in a storage tank 24 to the heat exchanger, and a boil-off vapor line 28 leads from the storage tank to the low-stage compressor. An pressurized vapor line 30 leads from the low-stage compressor to the heat exchanger. An output line 32 extends from the heat exchanger.

The boil-off vapor line 28 carries boil-off vapor from the storage tank 24 through the cooler 14 to a low-stage inlet 36 on the low-stage compressor 12. In the compressor, the boil-off vapor is pressurized before being directed to the cooler 14 through the pressurized vapor line 30.

Preferably, the low-stage compressor 12 is capable of pressurizing boil-off vapor from a liquid natural gas terminal to a pressure of at least 100 psi. However, how much pressurization is necessary generally depends upon how much nitrogen is contained in the boil-off vapor. If there were no nitrogen in the boil-off vapor, a pressure of a few psi may be sufficient.

The illustrated cooler 14 cools the pressurized vapor in the pressurized vapor line 30 to near cryogenic temperature. The illustrated cooler includes a preliminary cooler 40 and a high-pressure gas exchanger 42 in which the pressurized vapor is cooled against the vapor in the boil-off vapor line 28. Other arrangements for the cooler can, of course, be used. If the low-stage compressor 12 is capable of cryogenic operation, then the cooler 14 (or either the preliminary cooler 40 or the high-pressure gas exchanger 42) may not be required.

Before reaching the heat exchanger 16, the cooled, pressurized boil-off vapor may be further cooled to even nearer cryogenic temperature. The figure shows one way in which such further cooling—or desuperheating—can be achieved. In the illustrated embodiment of the invention, the cooled, pressurized vapor is mixed with cryogenic liquid from the storage tank 24 that is provided through a branch 44 on the liquid supply line 20. A valve 46 that is mounted on the branch can be used to control the amount of liquid added to the cooled, pressurized vapor. Preferably, the cooled, pressurized vapor is desuperheated to within about 5 degrees F. of the temperature of cryogenic liquid in the liquid supply line.

Directly mixing liquid from the storage tank 24 with the cooled, pressurized vapor may lead to condensation in the pressurized vapor line 30. To address this, a separator 48 may be installed on the pressurized vapor line. The illustrated separator includes a condensate line 50 through which condensed liquid can be withdrawn through a separator outlet 52 and directed to the output line 32.

The illustrated heat exchanger 16 has a vapor inlet 54, a liquid inlet 56, a condensate outlet 58, and a secondary liquid outlet 60. The heat exchanger includes two separate paths. One path 62 leads from the vapor inlet to the condensate outlet. The other path 64 leads from the liquid inlet to the secondary liquid outlet.

Preferably, the heat exchanger 16 is a platefin heat exchanger or a plate frame heat exchanger. The vapor inlet 54 on the heat exchanger receives cool, pressurized boil-off vapor from the cooler 14, while the liquid inlet 56 receives cold liquid from the storage tank 24. Optionally, a valve 66 can be provided on the liquid supply line 20 to control the amount of cold liquid entering the heat exchanger. In the heat exchanger, the cool, pressurized boil-off vapor in the first path 62 is condensed against the liquid in the other path 64.

The condensed liquid leaves the heat exchanger 16 and enters the output line 32 through the condensate outlet 58. A receiver vessel 72 can be provided on the output line to collect condensed liquid from both the heat exchanger and from the separator 48. If provided, the receiver vessel may also include a liquid input line 74 that extends from the liquid supply line 20. A valve 76 may be provided on that liquid input line.

The liquid exiting the heat exchanger 16 through the secondary liquid outlet 60 may also be directed to the output line through a secondary exchanger line 70.

The illustrated output line 32 may be connected to a secondary stage output pump or to a liquid send-out line, as is conventionally known.

This description has been provided only for illustrative purposes. Many changes and modifications will be apparent to those skilled in the art. The full scope of the invention is set forth in the following claims.

1. A boil-off gas removal system for a liquid storage tank comprising:
a vapor outlet and a separate liquid outlet on the storage tank;
a low-stage compressor that is capable of pressurizing boil-off vapor;
a branch from the liquid outlet through which cryogenic liquid can be introduced to a pressurized vapor line leading from the low-stage compressor;
a cooler that receives pressurized vapor from the compressor and cools it to at least near cryogenic temperature;
a heat exchanger in which cooled, pressurized vapor travels in one path and is condensed against cryogenic liquid that travels in another, separate path; and
an output line from the heat exchanger that directs the condensed vapor for further pressurization.

2. A boil-off gas removal system for a liquid storage tank comprising:
a vapor outlet and a separate liquid outlet on the storage tank;
a low-stage compressor that is capable of pressurizing boil-off vapor;
a cooler that receives pressurized vapor from the compressor and cools it to at least near cryogenic temperature;
a heat exchanger in which cool, pressurized vapor travels in one path and is condensed against cryogenic liquid that travels in another, separate path, the cryogenic liquid coming from the liquid outlet on the storage tank; and
an output line from the heat exchanger that directs the condensed vapor for further pressurization.

3. A boil-off gas removal system as recited in claim 2, in which the low-stage compressor is capable of pressurizing boil-off vapor from a liquid natural gas terminal.

4. A boil-off gas removal system as recited in claim 2, in which the low-stage compressor is capable of pressurizing boil-off vapor from a liquid natural gas terminal to a pressure of at least about 100 psi.

5. A boil-off gas removal system as recited in claim 2, in which the heat exchanger is a platefin heat exchanger.

6. A boil-off gas removal system as recited in claim 2, in which the heat exchanger is a plate frame heat exchanger.

7. A boil-off gas removal system as recited in claim 2, in which a receiver vessel is provided on an output line from a condensate outlet on the heat exchanger, and is connected to the liquid outlet on the storage tank.

8. A boil-off gas removal system as recited in claim 2, in which a valve on a liquid supply line from the liquid outlet on the storage tank can be used to control the amount of cryogenic liquid flowing to the heat exchanger.

9. A boil-off gas removal system for a liquid storage tank comprising:
a low-stage compressor that is capable of pressurizing boil-off vapor from a vapor outlet on the storage tank;
a branch through which cryogenic liquid can be introduced to a pressurized vapor line leading from the low-stage compressor;
a heat exchanger in which cooled, pressurized vapor travels in one path and is condensed against cryogenic liquid from a separate liquid outlet on the storage tank that travels in another, separate path; and
an output line from the heat exchanger that directs the condensed vapor for further pressurization.

10. A boil-off gas removal system as recited in claim 9, in which the branch comes from the liquid outlet and enables the desuperheating of pressurized vapor in the pressurized vapor line.

11. A boil-off gas removal system for a liquid storage tank comprising:
a low-stage compressor that is capable of pressurizing boil-off vapor from a vapor outlet on the storage tank;
a branch on a liquid supply line through which cryogenic liquid can be introduced to a pressurized vapor line leading from the low-stage compressor, the branch enabling the cooling of pressurized vapor in the pressurized vapor line to within about 5 degrees F. of the temperature of liquid in the liquid supply line;
a heat exchanger in which cooled, pressurized vapor travels in one path and is condensed against cryogenic liquid that travels in another, separate path; and
an output line from the heat exchanger that directs the condensed vapor for further pressurization.

12. A boil-off gas removal system as recited in claim 9, in which a separator is provided on the pressurized vapor line.

13. A boil-off gas removal system as recited in claim 9, in which the branch has a valve that controls the amount of cryogenic liquid introduced to the pressurized vapor line.

14. A boil-off gas removal system as recited in claim 1, in which the cryogenic liquid in the heat exchanger comes from the liquid outlet on the storage tank
